(19) United States
(12) Patent Application Publication
(10) Pub. No.: US 2020/0108715 A1
(43) Pub. Date: Apr. 9, 2020

(54) PROPELLER SHAFT YOKE WITH IMPROVED TOOL CLEARANCE

(71) Applicant: Neapco Intellectual Property Holdings, LLC, Farmington Hills, MI (US)

(72) Inventors: Victor S. Sanchez, Warren, MI (US); Robert J. Wehner, Livonia, MI (US); Alec Hopkins, Northville, MI (US)

(21) Appl. No.: 16/591,803

(22) Filed: Oct. 3, 2019

Related U.S. Application Data
(60) Provisional application No. 62/740,599, filed on Oct. 3, 2018.

(51) Int. Cl. B60K 17/24; F16D 3/205

(52) U.S. Cl. CPC B60K 17/24; F16D 2250/0084; F16D 2300/12; F16D 3/205

(57) ABSTRACT

A driveshaft apparatus includes a main driveshaft, a collar, and a driveshaft yoke, which attaches to a flange yoke via a cardan joint. The flange yoke is configured to attach to a transmission, transfer case or differential, where the torque from the transmission or transfer case is transmitted through the driveshaft to the differential or drive axle. The driveshaft yoke includes a stem portion having a reduced diameter relative to the main driveshaft, which may be in the form of a tube. The reduced diameter of the stem portion shifts the larger diameter further away from the flange yoke, and provides an annular space outside of the stem portion. The annular space provides increased clearance to a tool used to drive the bolts that attach the flange yoke to the transmission, transfer case, drive axle, or the differential. The stem portion may attach to the driveshaft via the collar.

### CROSS-REFERENCE TO RELATED APPLICATION

This application claims the benefit of U.S. Provisional Application Ser. No. 62/740,599, filed on Oct. 3, 2018, the entire disclosure of which is incorporated herein by reference.

### TECHNICAL FIELD

The present disclosure relates to vehicle driveline systems. More particularly, the present disclosure relates to a yoke and joint system for an improved vehicle driveline system.

### BACKGROUND OF THE INVENTION

Passenger vehicles include a multitude of mechanical connections for transferring rotational movement from the vehicle transmission to the vehicle wheels. The vehicle transmission is powered by an internal combustion engine or an electric motor, with the transmission producing an output in the form of rotation movement, thereby producing a torque that may be transferred through the various mechanical connections in the vehicle to drive the wheels, whether in a front-wheel drive vehicle, a rear-wheel drive vehicle, four-wheel drive vehicle, or all-wheel drive vehicle.

A driveline system in the vehicle connects the transmission to the wheels. The driveline system includes a driveshaft or propeller shaft, which is coupled to the transmission at one end and to a differential at the opposite end. The driveshaft will receive the torque from the transmission and transmit the torque via rotation of the driveshaft to the differential. The differential will convert the rotational movement of the driveshaft to half shafts that extend from the differential to the vehicle wheels to drive the wheels.

The connection between various components of the driveline can be made in the form of unitized connectors. Connectors may be in the form of cardan joints or constant velocity joints (CV joints). These unitized connectors allow the rotation of connected shafts to be transferred therebetween while allowing the shafts to be disposed at an angle relative to each other. In a connection between a half shaft and a wheel, for example, a CV joint may be used, allowing for a substantial angular difference between the wheel and the half shaft, which occurs during steering. In a connection between the transmission and the driveshaft, the angular displacement may be nominal, such that a cardan joint may typically be used. Similarly, a connection between portions of a multi-piece driveshaft may also be made using a cardan joint, allowing for the accounting of various manufacturing tolerances.

In a cardan joint connection, a pair of yokes may be connected via the cardan joint. One yoke may be attached to one shaft, with the other yoke being attached to another shaft. Alternatively, one yoke may be connected to a shaft, such as the driveshaft, with the other yoke being attached to a flange that connects to the transmission, transfer case, or drive axle.

Traditional vehicle assemblies require various previously manufactured and assembled components to be joined with other previously manufactured and assembled components. For example, a driveline assembly or the driveshaft thereof may be manufactured separately from the transmission, transfer case, or drive axle. Similarly, the transmission, transfer case, or drive axle may be installed in the vehicle before or after the driveshaft has been installed in the vehicle. Accordingly, the connection between the driveshaft and the transmission, transfer case, or drive axle will occur after one of these components has been previously installed. To attach the driveshaft to the transmission, transfer case, or drive axle, the flange at the end of the driveshaft will be attached via bolts or the like to a corresponding flange of the transmission, transfer case, or drive axle.

Attaching the driveshaft to the transmission, transfer case, or drive axle can be difficult given space constraints in the vehicle during assembly. A bolt driving tool having a bend may be used to drive the bolts that attach the flange to the transmission. As illustrated in FIG. 2, the bolt driving tool may be an elongate tool with a 90 degree bend at one end, such that the end of the tool extends in a direction corresponding to the longitudinal direction of the driveshaft and the direction for driving the bolts, with the handle portion tool extending perpendicular to the end portion. To make the bend in the tool, the tool may include a differential-type mechanism at the bend location, which requires an oversized housing at the location of the bend. Due to space constraints, and as further illustrated in FIG. 2, the enlarged size of the bolt driving tool at this bend can interfere with or contact the driveshaft at a location near the yoke that connects to the joint, making it difficult to easily access the bolts for attaching the flange.

Accordingly, a continuing need exists for improvements to a connection between the driveshaft and transmission and the assembly thereof.

### SUMMARY OF THE INVENTION

A driveshaft apparatus is provided, including a driveshaft having a longitudinal axis extending between first and second ends thereof and a collar member coaxial with the driveshaft and having first and second ends, wherein the first end of the collar member is attached to the first end of the driveshaft. A yoke member is coaxial with the driveshaft and has first and second ends, wherein the first end is attached to the second end of the collar member. The yoke member includes a stem portion and arms extending radially outward from the stem. The stem portion has an outer diameter that is reduced relative to an outer diameter of the driveshaft and that is reduced relative to the overall span of the arms. A space is defined radially outward from at least a portion of the stem that is radially between the outer diameter of the stem and the outer diameter of the driveshaft such that a tool can access the space and be at least partially disposed radially inward from the outer diameter of the driveshaft without interfering with the stem.

According to another aspect of the disclosure, a method for attaching a driveshaft to a rotatable vehicle flange is provided. The method includes installing a driveshaft flange yoke on the vehicle flange, wherein the driveshaft flange yoke is connected to a driveshaft yoke via a cardan joint, and the driveshaft yoke is connected to a driveshaft tube having a longitudinal axis. The method further includes inserting a bolt axially through the driveshaft flange yoke and into engagement with the vehicle flange, engaging the bolt with a bolt driving tool and driving the bolt through the driveshaft flange yoke, and securing the driveshaft flange yoke to the vehicle flange. The method also includes locating a portion of the bolt driving tool in an annular space that surrounds the driveshaft yoke and is disposed radially between an outer diameter of the driveshaft yoke and an outer diameter of the driveshaft tube, wherein the outer diameter of the driveshaft yoke is smaller than the outer diameter of the driveshaft tube.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is a perspective view of a traditional yoke and flange connection and a bolt-driving tool for attaching the flange to a transmission or differential in a vehicle driveline;

FIG. 2 is a cross-sectional view of the traditional yoke and flange connection, illustrating an interference between the bolt-driving tool and a shaft of the driveline system;

FIG. 3 is a perspective view of a yoke and flange connection with a yoke having a shaft with a reduced diameter connected to a driveshaft tube via a collar, and a bolt-driving tool for attaching the flange to a transmission or differential in a vehicle driveline;

FIG. 4 is cross-sectional view of the yoke and flange of FIG. 3, illustrating the bolt-driving tool being free from interference with the yoke or shaft of the driveline system;

FIG. 5 is a cross-sectional view of an alternative connection between the yoke and the collar illustrating the yoke disposed in abutting relationship with the collar; and

FIG. 6 is a cross-sectional view of an alternative embodiment of the yoke and the collar in which the yoke and the collar are formed as a single monolithic piece, which is attached to the shaft of the driveline system.

### DETAILED DESCRIPTION OF THE ENABLING EMBODIMENTS

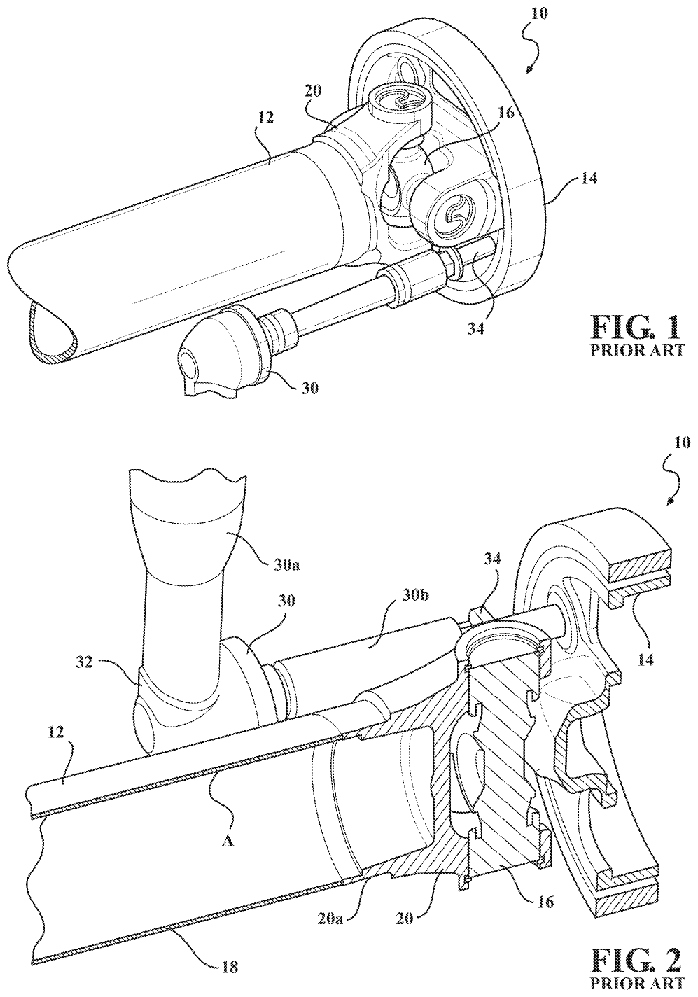

FIGS. 1 and 2 illustrate a prior art system 10 for connecting a shaft 12 with a flange yoke 14 via a cardan joint 16. The shaft 12 comprises a hollow tube 18, and includes a tube yoke 20 at one end, with the tube yoke 20 configured to attach to a cardan joint 16. The flange yoke 14 is similarly configured to attach to the cardan joint 16.

The tube yoke 20 includes a stem 20a that extends away from the cardan joint 16, with the stem 20a attached to the tube 18 to connect the tube yoke 20 and the tube 18 to form the shaft 12. The stem 20a has an outer diameter that corresponds to the diameter of the shaft 12. As best shown in FIG. 2, the stem 20a may have a wall thickness that increases as it extends away from the interface with the shaft 12.

As further illustrated in FIGS. 1 and 2, a bolt driving tool 30 includes a handle portion 30a extending perpendicular to the shaft 12, and a driving portion 30b extending parallel to the shaft 12. An elbow portion 32 joins, and is enlarged relative to, the handle portion 30a and the driving portion 30b. The driving portion 30b engages bolts 34 for fixing the flange yoke 14 to corresponding structure, such as a corresponding flange on a vehicle transmission (not shown). To effectively drive the bolts 34, the driving portion 30b is preferably aligned coaxially with the bolts 34, which places the driving portion 30b and the elbow 32 connected thereto in close proximity to the shaft 12 and the tube yoke 20.

The tube yoke 20 has a width that is only slightly smaller than the diameter of the flange yoke 14, such that the torque from the flange yoke 14 may be effectively transferred to the tube yoke 20. The bolts 34 are similarly disposed at a radially outer portion of the flange yoke 14. This arrangement leads to a limited amount of lateral space outside of the shaft 12 and the tube yoke 20. Accordingly, the tool 30 commonly interferes with the shaft 12 at location A, as shown in FIG. 2 when aligning the drive portion 30b with the bolts 34. Thus, the prior art arrangement illustrated in FIGS. 1 and 2 therefore makes connecting a pre-assembled system 10 with a separate transmission, transfer case, or differential difficult due to the interference or potential interference between the tool 30 and the shaft 12.

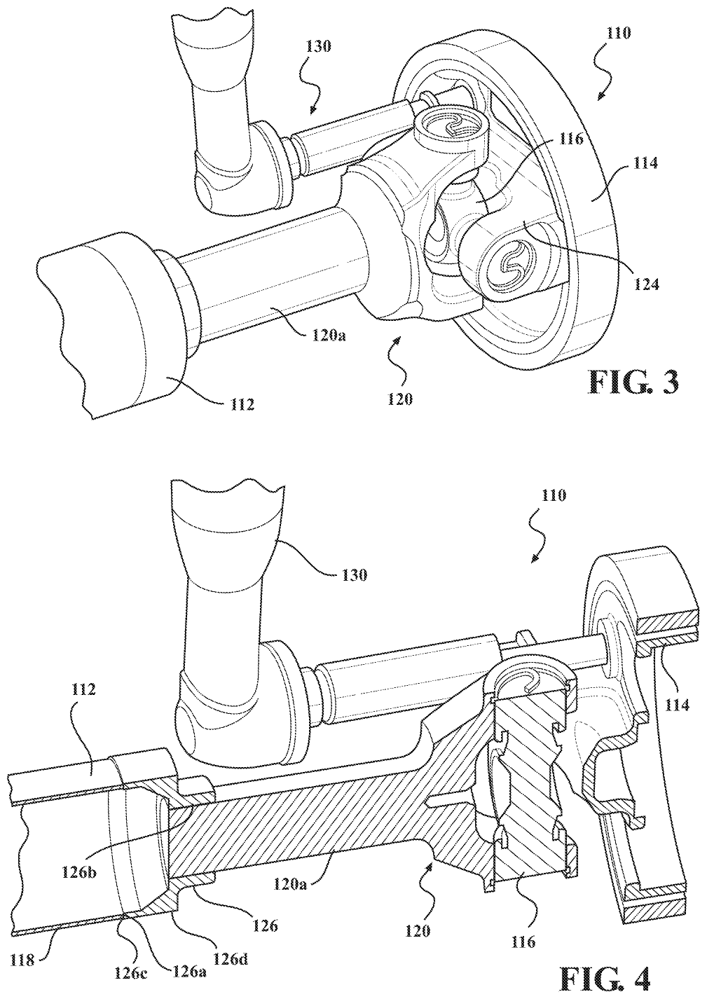

With reference to FIGS. 3 and 4, an improved system 110 is provided having a reduced diameter portion in the area of a tool 130. The system 110 includes a shaft 112, a flange yoke 114, and a cardan joint 116 that connects the shaft 112 to the flange yoke 114. The flange yoke 114 and cardan joint 116 may be the same as the flange yoke 14 and cardan joint 16 described above. However, the shaft 112 differs from the above described shaft 12, as further described below. The flange yoke 114 includes arm portions that are configured to attach to the cardan joint 116, with the arm portions extending from a generally circular flange portion, which is configured to attach to additional vehicle structure, such as a transmission, transfer case, or the like. The flange yoke 114 may be attached to the additional vehicle structure via bolts.

The shaft 112 may be in the form an assembly, wherein multiple components are joined together to form an integral structure. The shaft 112 includes a hollow tube 118 and a yoke 120, which may also be referred to as a driveshaft yoke 120, which connects to the cardan joint 116. It will be appreciated that the reference to the driveshaft yoke 120 may also apply to other types of shafts, or the like. The cardan joint 116 similarly connects to the flange yoke 114. The hollow tube 118 differs from the tube 18 described above in that the hollow tube 118 terminates at a location further away from the cardan joint 116 than the tube 18 terminates relative to the cardan joint 16 described above.

The shaft 112 further includes a collar member 126 disposed between the tube 118 and the driveshaft yoke 120. The collar member 126 connects the tube 118 and the driveshaft yoke 120. The collar member 126 may have a generally hollow shape with openings at opposite longitudinal ends. The collar 126 has a different diameter at each end to correspond to the structure of the shaft 118 and the driveshaft yoke 120, which are connected to the collar 126.

The driveshaft yoke 120 includes an elongate stem portion 120a that extends between the collar 126 and the arms of the driveshaft yoke 120 that connect to the joint 116. The arms of the driveshaft yoke 120 are similar to the arms of tube yoke 20, having a similar width and engagement with the joint 116. The arms of the driveshaft yoke 120 differ in that they extend away from the joint 116 and blend into the elongate stem portion 120a, which has a reduced diameter relative to the tube 118.

The stem portion 120a has a generally solid cross-section, which is different than the stem portion 20a. The stem portion 120a may have a length that is greater than the length of the arms of the driveshaft yoke 120. The diameter of the stem 120a is reduced relative to the tube yoke 20 of the prior design, which provides a clearance for the tool 130 that is not possible with the prior art system. The solid cross-section of the stem 120a allows for a comparable torque carrying capability compared to a larger diameter and thin-walled hollow stem.

In one approach, the stem 120a may include a bore (not shown) extending longitudinally through the stem 120a. In this approach, the bore is relatively small compared to the wall thickness of the stem 120a to ensure that the stem 120a can adequately transfer the torque produced in the system. Put another way, the width of the bore will be smaller than the thickness of the wall in the stem 120a in embodiments having such a bore.

The stem 120a is sized and arranged to mate with the collar 126. The collar 126 includes a first portion 126a that attaches to the tube 118 in a joined portion 126c and a second portion 126b that attaches to the stem 120a of the driveshaft yoke 120. The joined portion 126c may comprise a weld, interference fit, adhesive bond, or other common mechanical connection. The collar 126 defines a cavity extending longitudinally therethrough, such that the stem 120a may be inserted into the collar 126.

The first portion 126a of the collar 126 has a diameter that is greater than the diameter of the second portion 126b. The diameter of the first portion 126a may correspond generally to the diameter of the tube 118, because the first portion 126a mates with the tube 118. The outer diameter of the first portion 126a may be slightly larger than the outer diameter of the tube 118, and the inner diameter of the first portion 126a may be slightly smaller than the inner diameter of the tube 118. In this approach, the wall thickness of the tube 118 may be smaller than the wall thickness of the collar 126 in the area where the tube 118 mates with the collar 126. Alternate embodiments (not expressly illustrated) may comprise a collar 126 with outer diameter of the first portion 126a slightly smaller than the outer diameter of the tube 118, or an inner diameter of the first portion 126a slightly larger than the inner diameter of the tube 118.

The collar 126 at the first portion 126a thereof may define an annular end face at the joined portion 126c having a thickness defined by the difference between the outer and inner diameter of the first portion 126a. In this case, the thickness is defined by the end of the first portion 126a that is axially adjacent the tube 118. Thus, the thickness of the end face can be described as extending axially away from the tube 118 and toward the second portion 126b.

The second portion 126b of the collar 126 has a reduced outer diameter relative to the first portion 126a and the tube 118. The second portion 126b is configured to receive the stem 120a of the driveshaft yoke 120. Accordingly, the second portion 126 has an outer diameter that is greater than the outer diameter of the stem 120a. The second portion 126b has an inner diameter that generally corresponds to the outer diameter of the stem 120a, such that when the stem 120a is inserted into the second portion 126b of the collar 126, the stem 120a and the collar 126 will have an interference fit. It will be appreciated that a nominal space between the stem 120a and the collar 126 may alternatively exist when the stem 120a is inserted into the collar 126 to establish a clearance fit. As such, in this alternative arrangement, the diameter of the stem 120a may be sized and configured to be nominally smaller than the size of the inner diameter of the second portion 126a of the collar 126 to account for manufacturing tolerances and to ensure that the stem 120a may be received securely in the collar 126.

The collar 126 and stem 120a will overlap in the axial direction, with the collar 126 and stem 120a being coaxial with each other. The axial length of the overlap will depend on the length of the inner diameter of the first portion 126a of the collar 126, if the stem 120a is inserted fully into the collar 126. The amount of axial overlap may alternatively be controlled by the axial depth of insertion of the stem 120a into the collar 126. For example, the stem 120a may be inserted partially such that there is a portion of the inner diameter of the second portion 126b of the collar 126 that is axially beyond the end of the stem 120a. Alternatively, the length of the second portion 126b of the collar 126 may be extended to increase the amount of axial overlap.

The second portion 126b of the collar 126 has a thickness defined by the difference between the inner diameter of the second portion 126b and the outer diameter of the second portion 126b. The thickness of the second portion 126b may be greater than the thickness of the first portion 126a to facilitate comparable torque carrying capability as the first portion 126a.

The collar 126 may also include an intermediate portion 126d that is disposed between the first portion 126a and the second portion 126b. The intermediate portion 126d provides a transition between the first portion 126a and the second portion 126b. The intermediate portion 126d may include the maximum radial thickness of the collar 126, where the second portion 126b transitions to the first portion 126a. The thickness of the intermediate portion 126d may then decrease toward the first portion 126a. The intermediate portion 126d may decrease in thickness toward the first portion 126a as a taper or as stepped portions, or as a combination of tapers and steps. The intermediate portion 126d and the second portion 126b may combine to define the inner diameter of the collar 126 that receives the stem 120a, such that the stem 120a will axially overlap the intermediate portion 126d, at least in part.

The stem 120a, being received in the collar 126, is fixed to the collar 126 to define a rigid portion of the shaft 112 that is capable of transferring torque from the transmission or transfer case to the vehicle differential or drive axle. The stem 120a may be fixed to the collar 126 in different ways.

In one approach, the stem 120a is attached to the collar 126 via laser welding. The laser welding method may provide for a weld between the stem 120a and the collar 126 by producing a greater weld depth, which may be preferable when the stem 120a is inserted into the collar a substantial depth. Laser welding may provide a greater weld depth than a traditional MIG weld.

In another approach, a MIG welding process may be used, where the consumable electrode of the welding system provides a bead along the external interfaces between the stem 120a and the collar 126. The MIG weld may be applied at the outer end of the second portion 126b of the collar 126 as well as at the internal interface between the stem 120a and the collar 126, within the cavity defined by the collar 126.

In yet another approach, an ultrasonic welding process may be used to join the collar 126 and the stem 120a.

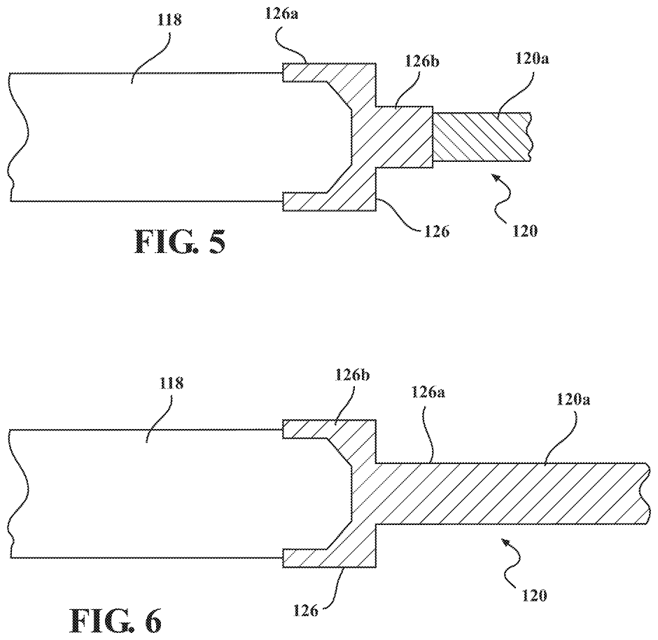

In yet another approach, shown in FIG. 5, the collar 126 may be manufactured without a through bore and corresponding inner diameter at the second portion 126b, such that the second portion 126b has a solid cross section with an outer diameter similar to the outer diameter of the shaft stem 120a to accommodate a radially oriented butt weld, including but not limited to a friction weld, inertia weld, or laser weld, or MIG weld. In this approach, the stem 120a abuts the collar 126. The outer diameter of the second portion 126b may be slightly larger than the diameter of the stem 120a at the location of the abutting connection.

In an alternative approach, the stem 120a and collar 126 may each include corresponded splined surfaces or profiles, where the outer surface of the stem 120a is splined and the inner surface of the second portion 126 of the collar 126 is splined. In this approach, the splined portions are fitted together, and the projections and recesses defined by the splined surfaces cooperate to transfer the torque in the system.

In yet another approach, as shown in FIG. 6, the driveshaft yoke 120 and the collar 126 may be manufactured as a single unitary piece. In this approach, the stem 120a of the driveshaft yoke 120 and the collar 126 would form a single piece having a shape that generally corresponds to the two-piece shape described above. In this approach, a weld or other manner of attachment would not be necessary between the driveshaft yoke 120 and collar 126. For example, the driveshaft yoke 120 and collar 126 may be cast, forged, sintered, machined, or otherwise manufactured as a single-piece.

The collar 126 is attached to the shaft 118 to transfer the torque in the system. As described above, the collar 126 may include an annular face with a thickness that is different than the thickness of the end of the shaft 118, but with similar general diameters. In this approach, the end of the shaft 118 may abut the end of the collar 126. The end of the shaft 118 may also include an annular face, such that the respective annular faces will face each other and contact each other.

The shaft 118 and the collar 126 may be joined together via a traditional MIG welding process, where a weld bead is created along the annular interface between the shaft 118 and the collar 126. The traditional MIG welding process may produce a relatively shallow depth of the weld pool, but the shaft 118 and collar 126 at this interface is relatively thin, such that a shallow weld pool is sufficient. Alternatively, other weld processes may be used, such as laser welding, friction welding, or ultrasonic welding.

In another approach, the inner diameter of the collar 126 may correspond to the outer diameter of the shaft 118, such that the shaft may be inserted into the collar 126, similar to the driveshaft yoke 120 being inserted at the opposite end of the collar 126. In this approach, the shaft 118 and the collar 126 may overlap axially. The components may be joined together via a traditional MIG weld at their exposed interfaces at both ends of the axial overlap. Alternatively, they may be laser welded together.

In yet another approach, the shaft 118 may have an inner diameter that corresponds to the outer diameter of the collar 126. In this approach, the collar 126 may be received in the cavity of the shaft 118, and the components may be welded together in a manner similar to that described above with respect to an axially overlapping connection.

In still another approach, the collar 126 may include an annular recess in its outer edge, with the recess sized to receive the annular end face of the shaft 118. The shaft 118 may thereby be inserted into the recess of the collar 126. The shaft 118 and the collar 126 may then be joined together by laser welding or MIG welding.

The combination of the reduced diameter driveshaft yoke 120, collar 126, and shaft 118 provides a mechanical system that can efficiently transfer the torque between the transmission or transfer case and the differential or drive axle in the vehicle. The reduced diameter portion of the driveshaft yoke 120 provides additional clearance for the tool 130 relative to prior driveshafts at the ends of the driveshaft where it connects to the transmission and the differential.

The reduced diameter portion of the driveshaft yoke 120 may be disposed at the ends of the driveshaft, such that an outer bearing assembly is not necessary to support the driveshaft. The lack of an outer bearing assembly supporting the driveshaft allows the outer surface of the driveshaft yoke 120 to be manufactured without a tight tolerance. Accordingly, the outer surface of the driveshaft yoke 120 in the area of the reduced diameter need not be a constant diameter or be machined or manufactured to include an outer bearing surface, thereby reducing the cost of manufacture.

The above described system may be used with existing tubular shaft sizes, with the shafts simply having a shorter length between ends relative to shafts that mate with the prior yokes. The length reductions in the shaft 118 are accounted for by the extended length of the stem 120a. The above described system may be used at both ends of the shaft 118 for connecting to both the transmission or transfer case and the differential or drive axle. Alternatively, the above described system may be used at one end of the shaft 118 for connecting to either the transmission, transfer case, or the differential, with the opposite end being connected to the prior yoke design, depending on the manufacturing needs of the vehicle in which the driveshaft is installed. For example, the driveshaft may come pre-assembled with an attached differential, such that access for the tool 130 may not be an issue at the differential.

The above described system has been described as being used at either end of the main driveshaft. However, the system may also be used at the ends of the other shafts, such as the half shafts at their attachment to the differential.

Obviously, many modifications and variations of the present invention are possible in light of the above teachings and may be practiced otherwise than as specifically described while within the scope of the appended claims. These antecedent recitations should be interpreted to cover any combination in which the inventive novelty exercises its utility.

What is claimed is:

1. A driveshaft apparatus comprising:
a driveshaft having a longitudinal axis extending between first and second ends thereof;
a collar member coaxial with the driveshaft and having first and second ends, wherein the first end of the collar member is attached to the first end of the driveshaft;
a yoke member coaxial with the driveshaft and having first and second ends, wherein the first end is attached to the second end of the collar member, wherein the yoke member includes a stem portion, and arms extending radially outward from the stem, wherein the stem portion has an outer diameter that is reduced relative to an outer diameter of the driveshaft and that is reduced relative to an overall span of the arms;
wherein a space is defined radially outward from at least a portion of the stem that is radially between the outer diameter of the stem and the outer diameter of the driveshaft such that a tool can access the space and be at least partially disposed radially inward from the outer diameter of the driveshaft without interfering with the stem.

2. The apparatus of claim 1 further comprising:
a cardan joint attached to the arms of the yoke; and
a flange yoke having arms attached to the cardan joint, wherein rotation of the flange yoke causes rotation via the cardan joint in the yoke, collar, and driveshaft.

3. The apparatus of claim 1, wherein the collar includes a first portion and a second portion, and the first portion has a greater diameter than the second portion.

4. The apparatus of claim 1, wherein the stem portion is axially longer than the arms of the yoke.

5. The apparatus of claim 1, wherein the stem portion has a constant outer diameter.

6. The apparatus of claim 1, wherein the stem portion has a solid cross-section.

7. The apparatus of claim 1, wherein the stem portion is received within the collar in an axially overlapping arrangement.

8. The apparatus of claim 1, wherein the stem portion is abutted to and adjoined to a first end of the collar member, and a second end of the collar member is attached to the driveshaft.

9. The apparatus of claim 1, wherein the stem portion is laser welded to the collar member.

10. The apparatus of claim 1, wherein the driveshaft is a hollow tube, the collar member includes a cavity extending therethrough, and the stem portion of the yoke has a solid cross-section at its attachment to the collar.

11. The apparatus of claim 2 further comprising a vehicle transmission attached to the flange yoke via bolts.

12. The apparatus of claim 3, wherein the first portion of the collar has a sidewall thickness that is smaller than a sidewall thickness of the second portion of the collar.

13. The apparatus of claim 1, wherein the stem portion of the yoke is free from attachment to a surrounding bearing structure.

14. The apparatus of claim 1, wherein the collar member and the yoke are in the form of a single monolithic unitary piece.

15. A method for attaching a driveshaft to a rotatable vehicle flange, the method comprising the steps of:
installing a flange yoke on the vehicle flange, wherein the flange yoke is connected to a driveshaft yoke via a cardan joint, and the driveshaft yoke is connected to a driveshaft tube having a longitudinal axis;
inserting a bolt axially through the flange yoke and into engagement with the vehicle flange;
engaging the bolt with a bolt driving tool and driving the bolt through the flange yoke and securing the flange yoke to the vehicle flange; and
locating a portion of the bolt driving tool in an annular space that surrounds the driveshaft yoke and is disposed radially between an outer diameter of the driveshaft yoke and an outer diameter of the driveshaft tube, wherein the outer diameter of the driveshaft yoke is smaller than the outer diameter of the driveshaft tube and smaller than the overall span of the cardan joint.

16. The method of claim 15, wherein the driveshaft yoke is attached to the driveshaft tube via a collar member.

17. The method of claim 15, wherein the driveshaft yoke includes an end portion defining the outer diameter of the driveshaft yoke and arms extending radially outward from the stem portion for connecting to the cardan joint.

18. The method of claim 17, wherein the end portion is attached to and disposed within a reduced diameter portion of a collar member, and a large diameter portion of the collar member is attached to the driveshaft tube.

19. The method of claim 18, wherein the end portion is inserted into the reduced diameter portion of the collar member and is fixed to the collar member via laser welding.

20. The method of claim 18, wherein the end portion has a solid cross-section at its attachment to the collar member.
